(19) United States
(12) Patent Application Publication
(10) Pub. No.: US 2023/0060083 A1
(43) Pub. Date: Feb. 23, 2023

(54) OBSTACLE DETECTION SYSTEM AND METHOD FOR VEHICLE

(71) Applicant: HYUNDAI MOBIS CO., LTD., Seoul (KR)

(72) Inventor: Eun Seok KANG, Yongin-si (KR)

(73) Assignee: HYUNDAI MOBIS CO., LTD., Seoul (KR)

(21) Appl. No.: 17/887,610

(22) Filed: Aug. 15, 2022

(30) Foreign Application Priority Data
Aug. 18, 2021 (KR) 10-2021-0108634

(51) Int. Cl. G01S 13/931; B60R 21/0134; B60Q 9/00

(52) U.S. Cl. CPC G01S 13/931; B60R 21/0134; B60Q 9/008

(57) ABSTRACT

A system for detecting an obstacle includes a detection sensor configured to detect a movement direction or movement speed of a target within a detection range of a vehicle, and form a tracking point for the detected target to track a movement of the target; and a controller configured to extend and track the tracking point based on the movement direction or the movement speed of the target tracked when the tracking point deviates from the detection range.

### CROSS REFERENCE TO RELATED APPLICATION

This application claims the benefit under 35 USC 119(a) of Korean Patent Application No. 10-2021-0108634, filed Aug. 18, 2021, the entire disclosure of which is incorporated herein by reference for all purposes.

### BACKGROUND OF DISCLOSURE

### Field of the Disclosure

The present disclosure relates to a system and method for detecting an obstacle for a vehicle, and is a technology for detecting a movement of an obstacle adjacent to the vehicle to warn of a collision with the vehicle.

### Description of the Related Art

In general, when driving a vehicle, a situation in a blind spot such as a rear and a side as well as a situation in a front acts as a very important factor. In particular, when changing lanes or moving backward, the risk of an accident can be prevented in advance only by recognizing the situation in the blind spot and then operating such as changing lanes or moving backward.

That is, when changing lanes or moving backward while driving, a driver determines the situation of the rear or both sides of a vehicle through the side mirrors protruding on both sides of the vehicle body or the room mirrors installed inside the vehicle, and then changes lanes or drives backward when the vehicle behind is in a safe condition with an appropriate distance, or when it is determined that there is no obstacle behind,

However, if the driver is inexperienced, it is unstable to determine the situation behind by looking at the side mirrors and the room mirrors while driving. Therefore, it may cause accidents such as collisions, and also it may not easy to reliably recognize obstacles in the rear.

Accordingly, in recent years, a system for preventing various safety accidents that may occur during driving of the vehicle in advance has been developed and is being mounted on the vehicle one after another. For example, the blind spot warning lamps on the side mirrors flicker to help the driver pay attention to the vehicle in the blind spot on the rear side. In situations such as parking, the driver can secure a rear view by using the rear camera on a trunk handle, or can detect obstacles with an ultrasonic or radar sensor installed in the blind spot.

The matters described as the background art above are only for improving the understanding of the background of the present disclosure, and should not be taken as acknowledging that they correspond to the prior art already known to those of ordinary skill in the art.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a system for detecting an obstacle includes a detection sensor configured to detect a movement direction or movement speed of a target within a detection range of a vehicle, and form a tracking point for the detected target to track a movement of the target; and a controller configured to extend and track the tracking point based on the movement direction or the movement speed of the target tracked when the tracking point deviates from the detection range.

The controller may be further configured to generate a warning signal by predicting a collision point or calculating a collision time between the vehicle and the obstacle based on the movement direction and the movement speed of the target tracked.

The controller may be further configured to set a preset entry angle within the detection range, and generate the warning signal when the detection sensor detects the movement of the target at the preset entry angle.

If the tracking point deviates from the detection range after the warning signal is generated, the controller may be further configured to extend and track the tracking point to maintain the warning signal up to a length of the extended tracking point.

If an angle of the movement direction of the target is gradually increased and an expected collision point is farther from the vehicle, the controller may be further configured to terminate the warning signal at a preset first position shorter than the length of the extended tracking point.

If an angle of the movement direction of the target is gradually increased and an expected collision point is closer to the vehicle, the controller may be further configured to terminate the warning signal at a preset second position shorter than the length of the extended tracking point.

If the speed of the target decreases and the target is stopped, the calculated predicted collision time may be increased and the controller may be further configured to terminate the warning signal.

The controller may be further configured to extend and track the tracking point to an outside of the detection range by a preset length.

In another general aspect, a method for detecting an obstacle includes detecting a movement direction or movement speed of a target within a detection range provided in a vehicle, tracking a movement of the target by forming a tracking point for the target, and extending and tracking the tracking point based on the movement direction or the movement speed of the target tracked by a detection sensor if the tracking point deviates from the detection range.

The method may further include generating a warning signal by predicting a collision point or calculating a collision time between the vehicle and the obstacle based on the movement direction and the movement speed of the target tracked in the tracking of the movement of the target.

The method may further include setting a preset entry angle within the detection range. In the generating of the warning signal, the warning signal may be generated if the movement of the target at the preset entry angle is detected in the tracking the movement of the target.

The method may further include extending and tracking the tracking point if the tracking point deviates from the detection range after the generating of the warning signal, and maintaining the warning signal by a length of the extended tracking point that is extended and tracked.

The method may further include terminating the warning signal at a preset first position shorter than the length of the extended tracking point if an angle of the movement direction of the target is gradually increased in the tracking of the target after the maintaining of the warning signal and the expected collision point is farther from the vehicle.

The method may further include terminating the warning signal at a preset second position shorter than the length of the extended tracking point if an angle of the movement direction of the target is gradually increased in the tracking of the target after the maintaining of the warning signal and the expected collision point is closer to the vehicle.

The method may further include terminating the warning signal if the speed of the target decreases and the target is stopped in the tracking of the target after the generating of the warning signal, and the calculated predicted collision time is increased.

In the extending and the tracking of the tracking point, the tracking point may be extended and tracked to an outside of the detection range by a preset length.

The system for detecting an obstacle for a vehicle according to the present disclosure detects an obstacle within the detection range of the detection sensor and forms the tracking point to track the movement of the obstacle, extends and tracks the tracking point if the tracking point deviates from the detection range and maintains the warning signal as much as the extended tracking, so that the warning signal can be maintained even when the rear portion of the obstacle is located within the detection range. Accordingly, there is an effect of preventing the vehicle from collided with the rear portion of the obstacle.

Other features and aspects will be apparent from the following detailed description, the drawings, and the claims.

### BRIEF DESCRIPTION OF THE DRAWINGS

FIG. 1 is a block diagram of a system for detecting an obstacle for a vehicle according to an embodiment of the present disclosure.

FIGS. 2 to 5 are views showing the detection of an obstacle according to various embodiments of the present disclosure.

FIG. 6 is a flowchart of a method for detecting an obstacle for a vehicle according to an embodiment of the present disclosure.

Throughout the drawings and the detailed description, the same reference numerals refer to the same or like elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Unless defined otherwise, all terms used herein, including technical and scientific terms, have the same meaning as commonly understood by one of ordinary skill in the art to which this disclosure belongs. Terms such as those defined in commonly used dictionaries should be interpreted as having meanings consistent with the context of the related art, and unless explicitly defined in the present specification, they are not to be interpreted in an ideal or excessively formal meaning.

An object of the present disclosure is to prepare for a collision between a vehicle and an obstacle by forming a tracking point by a detection sensor that detects an obstacle moving adjacent to a vehicle, and maintaining a warning signal when the formed tracking point deviates from a detection range and the rear portion of the obstacle is located in the detection range. Accordingly, the vehicle may be prevented from colliding with the rear portion of the obstacle.

A control unit (controller) 20 according to an exemplary embodiment of the present disclosure includes a non-volatile memory (not shown) configured to store data regarding an algorithm configured to control the operation of various components of a vehicle 100 or a software command for reproducing the algorithm, and a processor (not shown) configured to perform operations described below using the data stored in the corresponding memory. Here, the memory and the processor may be implemented as separate chips. Alternatively, the memory and processor may be implemented as a single chip integrated with each other. A processor may take the form of one or more processors.

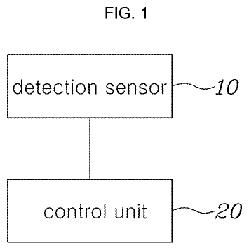

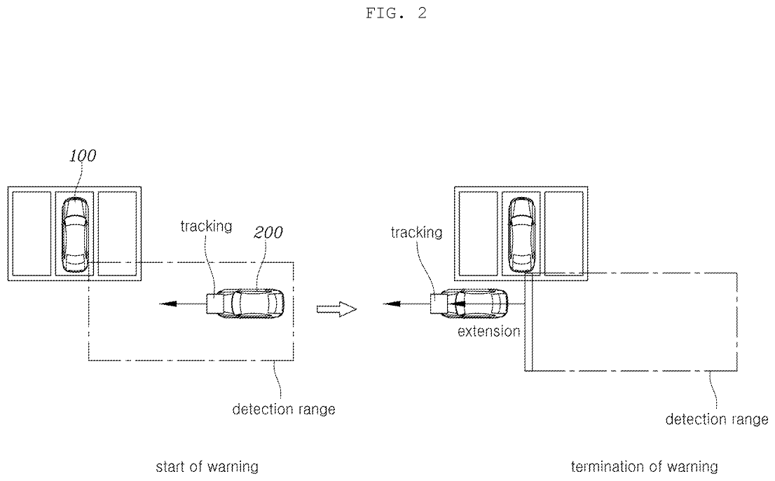

FIG. 1 is a block diagram of a system for detecting an obstacle for a vehicle 100 according to an embodiment of the present disclosure, and FIGS. 2 to 5 are views showing the detection of an obstacle according to various embodiments of the present disclosure.

The system for detecting an obstacle of the vehicle 100 according to the present disclosure includes a detection sensor 10 that is provided in the vehicle 100 to detect the movement direction or movement speed of a target 200 within a detection range, and forms a tracking point for the detected target 200 to track the movement of the target 200; and a control unit 20 that extends and tracks the tracking point based on the movement direction or movement speed of the target 200 tracked by the detection sensor 10 when the tracking point deviates from the detection range.

The detection sensor 10 detects the position of the obstacle located within the detection range, and generates a tracking point when the obstacle moves within the detection range to track the movement of the obstacle, so that the movement direction or movement speed of the obstacle can be detected.

The conventional detection sensor 10 detects an obstacle by forming a tracking point at a point where the obstacle is first detected. When the obstacle is an external vehicle 100, the tracking point may be the first point in the movement direction of the vehicle 100. When the detection is made in a state in which the external vehicle 100 moves forward, the tracking point is formed toward a front bumper, and when the detection is made in a state in which the external vehicle 100 moves backward, the tracking point is formed toward a rear bumper, so that the movement of the external vehicle 100 can be detected.

Also, the control unit 20 may generate a warning for the vehicle 100 in a range in which a collision with the vehicle 100 is predicted among the detection range of the detection sensor 10.

In the conventional system for detecting an obstacle of the vehicle 100, when the tracking point of the obstacle deviates from the detection range of the vehicle 100, the control unit 20 terminates the detection for the obstacle. When the tracking point is within a warning range, a warning signal is generated and when the warning signal is terminated, the detection is terminated. However, even after the tracking point deviates from the detection range, if the rear portion of the obstacle (external vehicle 100) still remains within the detection range, this causes a problem in that the vehicle 100 collides with the obstacle when moving.

Accordingly, the control unit 20 of the present disclosure can continue tracking the obstacle by extending the tracking point in the direction in which the tracking point moves when tracking the tracking point.

Through this, even if the rear portion of the obstacle is located within the detection range after the tracking point deviates from the detection range of the detection sensor 10, it is continuously detected to prevent collision of the vehicle 100 with the obstacle.

The control unit 20 may generate a warning signal by predicting a collision point or calculating a collision time between the vehicle 100 and an obstacle based on the movement direction and movement speed of the target 200 tracked by the detection sensor 10.

The detection sensor 10 may detect the position of the obstacle to form a tracking point, and track the movement of the tracking point to detect the movement direction and movement speed of the obstacle.

Accordingly, if the obstacle moves outside the detection range, the control unit 20 may extend and track the tracking point based on the movement direction and movement speed of the obstacle detected by the detection unit.

The control unit 20 may set a preset entry angle within the detection range, and generate a warning signal if the detection sensor 10 detects the movement of the target 200 at the preset entry angle.

The control unit 20 may set an angle at which the obstacle enters the vehicle 100 based on the movement direction of the vehicle 100 detected by the detection unit and an entry angle of the obstacle at which the vehicle 100 is expected to collide with the obstacle through the movement direction of the vehicle 100. The control unit 20 may generate a warning signal when the obstacle enters at the set entry angle.

Through this, if the warning signal is generated in the vehicle 100 driven by the driver, the driver stops the driving of the vehicle 100. Also, in the case of the autonomous vehicle 100, if the obstacle enters at the set entry angle, the control unit 20 stops the driving of the vehicle 100 in order to prevent a collision accident between the vehicle 100 and the obstacle.

If the tracking point deviates from the detection range after the warning signal is generated, the control unit 20 may extend and track the tracking point to maintain the warning signal by the length of the extended tracking point.

The control unit 20 predicts the possibility of collision based on the movement angle of the obstacle and the vehicle 100 when tracking the tracking point. If the tracking point to be tracked deviates from the detection range of the detection sensor 10, the control unit 20 extends and tracks the tracking point in the direction of movement of the obstacle. If the warning signal is generated, the control unit 20 may generate the warning signal as much as the extended length of the tracking point to be extended and tracked.

As shown in FIG. 2, as a first embodiment of the present disclosure, if an obstacle moves from the rear side of the vehicle 100, a tracking point is formed and detected, and a warning signal is generated if a collision between the vehicle 100 and the obstacle is predicted, if the obstacle moves out of the detection range, the tracking point is extended and tracked, and the warning signal can be extended accordingly. In this case, the lateral distance between the vehicle 100 and the obstacle is gradually decreased, and if the lateral distance becomes zero (0), the tracking of the tracking point may be extended and tracked.

Through this, it is possible to generate a warning signal of the vehicle 100 until the time when all the obstacles deviate from the detection range of the detection sensor 10.

If the angle of the movement direction of the target 200 is gradually increased and the expected collision point is closer to the vehicle 100, the control unit 20 may terminate the warning signal at a preset first position shorter than the length of the extended tracking point.

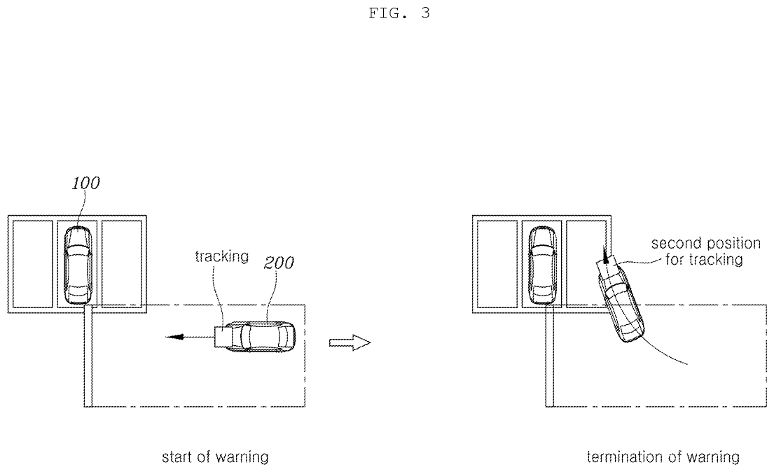

As a second embodiment of the present disclosure, as shown in FIG. 3, the entry angle of the obstacle is changed and the angle is gradually increased, and the longitudinal distance between the obstacle and the vehicle 100 becomes closer. The tracking may be extended in a direction extending the movement direction of the obstacle. In this case, the control unit 20 may detect that the lateral distance between the vehicle 100 and the obstacle is not zero (0), and extend the tracking to the first position shorter than the extended tracking length.

The lateral distance between the vehicle 100 and the obstacle does not become zero (0), and as the movement angle of the obstacle gradually increases, the possibility of a collision between the vehicle 100 and the obstacle may gradually decrease.

If the possibility of collision between the vehicle 100 and the obstacle is low as the tracking is terminated at the first position, unnecessary warning signals can be reduced.

If the angle of the movement direction of the target 200 is gradually increased, and the expected collision point is farther from the vehicle 100, the control unit 20 may terminate the warning signal at a preset second position shorter than the length of the extended tracking point.

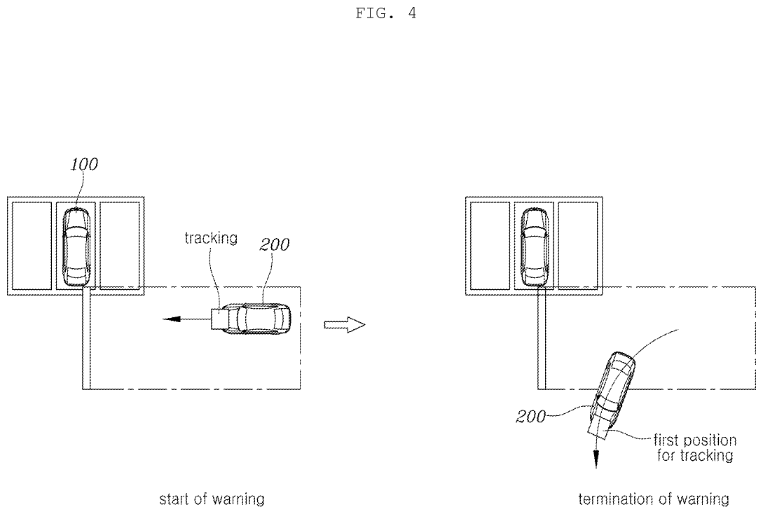

As a third embodiment of the present disclosure, as shown in FIG. 4, the entry angle of the obstacle is changed and the angle is gradually increased, and the longitudinal distance between the obstacle and the vehicle 100 is increased. The tracking can be extended in a direction extending the movement direction of the obstacle. In this case, the control unit 20 may detect that the lateral distance between the vehicle 100 and the obstacle is not zero (0), and extend the tracking to a second position shorter than the length of the extended first position.

In the third embodiment, the distance between the vehicle 100 and the obstacle is gradually increased, and thus the possibility of collision between the vehicle 100 and the obstacle is reduced. Accordingly, it is possible to reduce the driver's fatigue by extending the tracking to be shorter than the first position and terminating the warning signal early.

If the speed of the target 200 is reduced and the target is stopped, the calculated predicted collision time may be increased and the control unit 20 may terminate the warning signal.

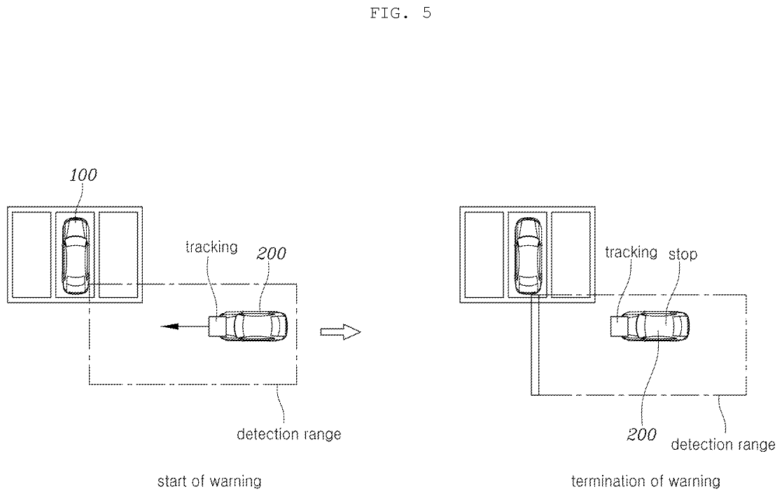

As a fourth embodiment according to the present disclosure, as shown in FIG. 5, if the vehicle 100 stops within the detection range, the detection sensor 10 detects the movement speed of the obstacle as zero (0) when tracking the obstacle, and the control unit 20 may immediately terminate the warning signal when the obstacle is stopped.

In this way, unnecessary warning signals can be reduced.

The control unit 20 may extend and track the tracking point to the outside of the detection range by a preset length.

The control unit 20 may extend and track the tracking point by a preset length when extending the tracking. Alternatively, the control unit 20 may set the length of the obstacle and extend and track the tracking point by the preset length of the obstacle to the outside of the detection range of the detection sensor 10 based on the movement speed and movement direction of the obstacle.

The preset length of the obstacle or the tracking length may be set to 4M to 5M, which is a general length of a sedan.

Through this, it is possible to prepare for a collision between the vehicle 100 and the obstacle by extending the warning signal until the time when the obstacle completely moves out of the detection range of the detection sensor 10.

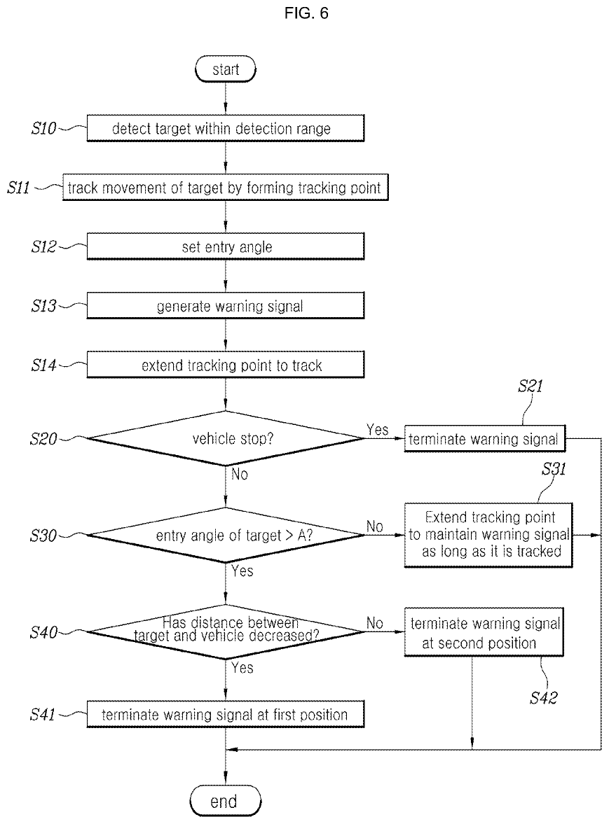

FIG. 6 is a flowchart of a method for detecting an obstacle for the vehicle 100 according to an embodiment of the present disclosure.

A preferred embodiment of a method for detecting an obstacle for the vehicle 100 according to the present disclosure will be described with reference to FIG. 6.

A method for detecting an obstacle for the vehicle 100 according to the present disclosure includes the operations of detecting a movement direction or movement speed of the target 200 within a detection range provided in the vehicle 100 (S10); tracking the movement of the target 200 by forming a tracking point for the target 200 detected in the detecting operation (S10) (511); and extending and tracking the tracking point based on the movement direction or movement speed of the target 200 tracked by the detection sensor 10 if the tracking point deviates from the detection range (S14).

The method may further include the operation of generating the warning signal by predicting a collision point or calculating a collision time between the vehicle 100 and the obstacle based on the movement direction and movement speed of the target 200 tracked in the operation of tracking the movement of the target 200 (S13).

The method may further include the operation of setting a preset entry angle within the detection range (S12). In the operation of generating the warning signal (S13), the warning signal may be generated if it is detected that the target 200 moves at the preset entry angle in the operation of tracking the movement of the target 200.

The operation of extending and tracking the tracking point is performed (S14) if the tracking point deviates from the detection range after the operation of generating the warning signal (S13), and the method may further include the operation of maintaining the warning signal as much as the length of the extended tracking point by extending and tracking the tracking point (S31).

The method may further include the operation of terminating the warning signal at a preset first position shorter than the length of the extended tracking point (S41) if the angle of the movement direction of the target 200 is gradually increased in the operation of tracking the target 200 after the operation of generating the warning signal (S13), and the expected collision point is farther from the vehicle 100 (S40).

The method may further include the operation of terminating the warning signal at a preset second position shorter than the length of the extend tracking point (S42) if the angle of the movement direction of the target 200 is gradually increased in the operation of tracking the target 200 after the operation of generating the warning signal (S13), and the expected collision point is closer to the vehicle 100 (S40).

The method may further include the operation of terminating the warning signal (S21) if the speed of the target 200 is decreased and the target is stopped in the operation of tracking the target 200 after the operation of generating the warning signal (S13) and the calculated predicted collision time is increased.

In the operation of extending and tracking the tracking point (S14), the tracking point may be extended and tracked to the outside of the detection range by a preset length.

The detection sensor and control unit in FIGS. 1-6 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A system for detecting an obstacle, comprising:
a detection sensor configured to detect a movement direction or movement speed of a target within a detection range of a vehicle, and form a tracking point for the detected target to track a movement of the target; and
a controller configured to extend and track the tracking point based on the movement direction or the movement speed of the target tracked when the tracking point deviates from the detection range.

2. The system of claim 1, wherein the controller is further configured to generate a warning signal by predicting a collision point or calculating a collision time between the vehicle and the obstacle based on the movement direction and the movement speed of the target tracked.

3. The system of claim 2, wherein the controller is further configured to set a preset entry angle within the detection range, and generate the warning signal when the detection sensor detects the movement of the target at the preset entry angle.

4. The system of claim 2, wherein if the tracking point deviates from the detection range after the warning signal is generated, the controller is further configured to extend and track the tracking point to maintain the warning signal up to a length of the extended tracking point.

5. The system of claim 4, wherein if an angle of the movement direction of the target is gradually increased and an expected collision point is farther from the vehicle, the controller is further configured to terminate the warning signal at a preset first position shorter than the length of the extended tracking point.

6. The system of claim 4, wherein if an angle of the movement direction of the target is gradually increased and an expected collision point is closer to the vehicle, the controller is further configured to terminate the warning signal at a preset second position shorter than the length of the extended tracking point.

7. The system of claim 2, wherein if the speed of the target decreases and the target is stopped, the calculated predicted collision time is increased and the controller is further configured to terminate the warning signal.

8. The system of claim 1, wherein the controller is further configured to extend and track the tracking point to an outside of the detection range by a preset length.

9. A method for detecting an obstacle, comprising:
detecting a movement direction or movement speed of a target within a detection range provided in a vehicle;
tracking a movement of the target by forming a tracking point for the target; and
extending and tracking the tracking point based on the movement direction or the movement speed of the target tracked by a detection sensor if the tracking point deviates from the detection range.

10. The method of claim 9, further comprising generating a warning signal by predicting a collision point or calculating a collision time between the vehicle and the obstacle based on the movement direction and the movement speed of the target tracked in the tracking of the movement of the target.

11. The method of claim 10, further comprising setting a preset entry angle within the detection range,
wherein in the generating of the warning signal, the warning signal is generated if the movement of the target at the preset entry angle is detected in the tracking the movement of the target.

12. The method of claim 10, further comprising extending and tracking the tracking point if the tracking point deviates from the detection range after the generating of the warning signal, and maintaining the warning signal by a length of the extended tracking point that is extended and tracked.

13. The method of claim 12, further comprising terminating the warning signal at a preset first position shorter than the length of the extended tracking point if an angle of the movement direction of the target is gradually increased in the tracking of the target after the maintaining of the warning signal and the expected collision point is farther from the vehicle.

14. The method of claim 12, further comprising terminating the warning signal at a preset second position shorter than the length of the extended tracking point if an angle of the movement direction of the target is gradually increased in the tracking of the target after the maintaining of the warning signal and the expected collision point is closer to the vehicle.

15. The method of claim 10, further comprising terminating the warning signal if the speed of the target decreases and the target is stopped in the tracking of the target after the generating of the warning signal, and the calculated predicted collision time is increased.

16. The method of claim 10, wherein in the extending and the tracking of the tracking point, the tracking point is extended and tracked to an outside of the detection range by a preset length.
